(19) United States
(12) Patent Application Publication
(10) Pub. No.: US 2006/0286945 A1
(43) Pub. Date: Dec. 21, 2006

(54) Inter-frequency handover for multiple antenna wireless transmit/receive units

(75) Inventors: Alexander Reznik, Titusville, NJ (US); Gregory S. Sternberg, Great Neck, NY (US)

Correspondence Address: Donald M. Boles, Esq.;InterDigital Communications Corporation, 781 Third Avenue, King of Prussia, PA, 19406, US

(73) Assignee: InterDigital Technology Corporation, Wilmington, DE (US)

(21) Appl. No.: 11/156,359

(22) Filed: Jun. 17, 2005

(51) Int. Cl. H04B 1/02; H04B 7/02

(52) U.S. Cl. 455/101

(57) ABSTRACT

A method and an apparatus for a Wireless Transmit/receive Unit (WTRU) to perform inter-frequency measurements and inter-frequency soft handover from an originating Base Station (BS) operating at a first frequency to a destination BS operating at a second frequency. The WTRU has at least two antennas, where each antenna initially receiving at the first frequency. The method of the invention performs inter-frequency measurements of the channel on the second frequency using at least one of the antennas that were used for performing data reception on the first frequency. The invention includes a method and an apparatus for performing inter-frequency handover. The inter-frequency handover includes soft handover and hard handover.

### CROSS REFERENCE TO RELATED APPLICATION(S)

This application claims priority from U.S. provisional application no. 60/518,144, filed Nov. 7, 2003, which is incorporated by reference as if fully set forth.

### FIELD OF INVENTION

The present invention relates to handover in a wireless communication system, and more particularly, to a method for performing an inter-frequency handover in a wireless transmitter/receiver unit having at least two antennas.

### BACKGROUND

In cellular networks, mobile wireless transmitter/receiver units (WTRU) communicate with base stations (BS). When a mobile subscriber moves within the cellular network, the network hands over the wireless transmitter/receiver unit from one base station to another in order to maintain connectivity. There are challenges in designing cellular systems that perform handover between BSs located in different frequencies, especially in the design of cellular Code Division Multiple Access (CDMA) WTRUs that operate using the Frequency Division Duplex (FDD) mode. One reason for the design challenges associated with inter-frequency handover is that numerous measurements must be made at the destination BS prior to the initiation of the handover process from the BS of origin to the destination BS. Moreover, these measurements must be made while the WTRU maintains communication with the BS of origin. In certain systems, such as TDMA systems, the WTRU has available time intervals or timeslots when it is not actively communicating with the BS of origin, and these timeslots may be used to perform inter-frequency measurements of signals from one or more destination BSs. However, this is not true for CDMA systems where communication is typically continuous. Thus, it is necessary for a CDMA WTRU to simultaneously receive signals on two or more different frequency bands.

Another reason why inter-frequency handover creates a problem in CDMA systems is the inability to support soft handover at the WTRU. A handover process is termed “soft” when a WTRU communicates simultaneously with both the BS of origin and the destination WTRU. This may generally be performed when both BS's utilize CDMA technology for communication. Soft handover improves WTRU receiver performance during the handover process, and in particular, in CDMA systems, it is often necessary to reduce the probability of a call being dropped during the handover process.

One method for solving the handover problems described thus far is by introducing a second radio into the WTRU that is dedicated to inter-frequency measurements. Since inter-frequency measurements are only performed periodically, using a dedicated radio for measurements would waste resources. While this does allow a WTRU to simultaneously receive signals from two frequency bands, it is costly, increases the WTRUs power consumption, and is therefore undesirable. Moreover, this method does facilitate inter-frequency soft handover.

An alternate solution, made available by the UMTS WCDMA FDD mode standard, is the use of “compressed mode.” In compressed mode, transmissions to a WTRU are interrupted at a predefined time for a predefined period of time so that the WTRU may tune its radio to a different frequency and perform the necessary measurements. While this does enable WTRU design without a second dedicated radio for inter-frequency measurements, it also creates several problems, as follows:

Since a pre-defined data rate must often be maintained, the data that is to be sent during the compressed mode “gap interval” must be buffered at the BS and then sent with other data. This creates intervals in the transmission to the WTRU where higher data rate delivery is required (transmission gap recovery), which in turn uses up the total system resources and decreases capacity.

Additionally, supporting compressed mode in the WTRU requires significant additional logic which may impact the complexity and performance of the overall receiver.

Additionally, inter-frequency soft handover cannot be supported, since only one radio is actually present, and therefore only a single frequency can be demodulated at any given instant in time.

Therefore, there exists a need for a method of performing measurements to support inter-frequency handover without utilizing a radio dedicated for this purpose or requiring the use of compressed mode.

### SUMMARY OF THE INVENTION

The present invention discloses a method and apparatus for a Wireless transmitter/receiver unit (WTRU) that already possesses at least two receive antennas that are used for multi-antenna receive diversity reception to perform inter-frequency measurements; first the WTRU performs a channel quality measurements, of the first frequency, per-antenna at the receiver of the WTRU, second, by selecting at least one antenna to perform inter-frequency measurements, third, by having the WTRU instruct the network to transmit at a higher power, fourth, by having the WTRU switch at least one selected antenna to perform inter-frequency measurements. When inter-frequency measurements are complete, the WTRU switches the at least one selected antenna back to the first frequency and to be utilized as receive diversity antennas, then the WTRU instructs the network to return the power level/data rate to the settings prior to the commencement of the inter-frequency measurement process. It should be noted that selecting the antenna(s) for inter-frequency measurement can be selected arbitrarily or based on other criteria, and not based on channel quality measurements.

The present invention discloses a method and apparatus for a Wireless transmitter/receiver unit (WTRU) that already possesses at least two receive radios that are used for multi-antenna receive diversity reception to perform inter-frequency handover; first the WTRU performs a channel quality measurements of the first frequency per-antenna at the receiver of the WTRU, second, the WTRU selects at least one antenna to perform inter-frequency measurements, third, when the WTRU selects at least one antenna for inter-frequency handover, the selected antenna(s) may be switched to the second frequency. At this point the receiver may either begin demodulating data from the second frequency only, abandoning data demodulation from the first frequency. Alternatively, the receiver may combine signals from the two frequencies, which results in a soft inter-frequency handover. Finally, the inter-frequency handover process is completed when all the antennas are switched to the second frequency. It should be noted that selecting the antenna(s) for inter-frequency handover can be selected arbitrarily or based on other criteria, and not based on channel quality measurements.

The invention includes a WTRU for performing inter-frequency measurements and inter-frequency handover. The WTRU includes at leas two antennas for receiving signals at different frequencies. The WTRU includes a channel estimation element to estimate the quality of the channel for each of each of the antennas in the WTRU.

The WTRU in the invention includes an antenna selection element that is used to select the antenna or antennas to be used for performing inter-frequency measurements and will also be used in performing inter-frequency handover. In a preferred embodiment, the antenna selection element will select the antenna with lowest channel quality to perform inter-frequency measurements, based on the estimates of the channel estimation element.

The WTRU includes a communication element, for communication with the network to instruct the network to perform power control and rate control functions, when the WTRU initiates inter-frequency measurements and inter-frequency handover.

The WTRU includes a signal combining function for combining signals from at least two base stations operating at two different frequencies. The signal combining function can perform hard inter-frequency handover, or soft inter-frequency handover.

### BRIEF DESCRIPTION OF THE DRAWINGS

A more detailed understanding of the invention may be had from the following description of a preferred embodiment, given by way of example, and to be understood in conjunction with the accompanying drawings wherein:

FIG. 1 is a flow diagram showing a method for taking an inter-frequency measurement in accordance with the present invention; and

FIG. 2 is a flow diagram showing a method for performing an inter-frequency handover in accordance with the present invention.

FIG. 3 is a functional block diagram showing a WTRU for performing inter-frequency handover and inter-frequency measurement.

### DETAILED DESCRIPTION OF THE PREFERRED EMBODIMENT(S)

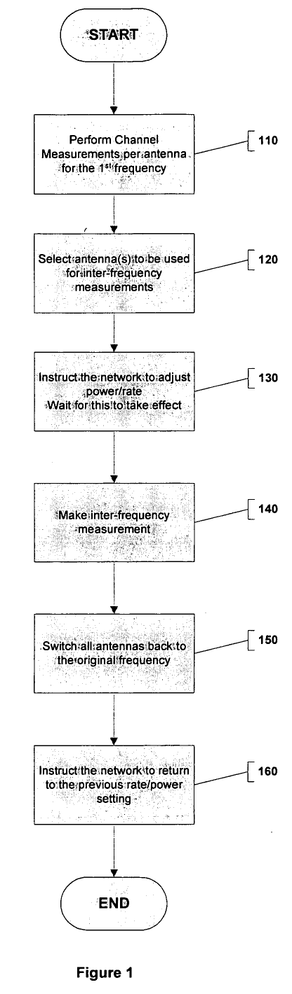

Code Division Multiple Access (CDMA) Wireless transmitter/receiver unit (WTRU) with at least two receive antennas and at least two radios, are typically utilized to improve receiver performance by implementing receive diversity. In implementing receive diversity, all antennas would typically be receiving data at the same frequency providing independent, or partially independent, observations of the received signal. However, to perform inter-frequency measurements, one of at least two antennas is selected to receive data at a second frequency to perform the measurements. This would present an advantage over the prior art by allowing an antenna that performs data communication to perform measurements periodically. The invention provides a method for performing inter-frequency measurements as shown in FIG. 1; first the WTRU performs a channel quality measurements per-antenna 110 at the receiver of the WTRU, second, at least one antenna is selected to be used for inter-frequency measurements 120, the number of antennas used for inter-frequency measurements should be at least 1 and no more than the total number of antennas present less 1, so that at least 1 antenna remains tuned to the original frequency. In doing so, the antennas with the worst channels are selected for the inter-frequency measurements, thus reducing the impact on the data reception performance. In another embodiment, the WTRU arbitrarily selects the antenna for performing inter-frequency measurements without basing the selection on the channel quality. It should be noted that selecting the antenna(s) for inter-frequency measurement can be selected arbitrarily or based on other criteria, and not based on channel quality measurements.

An abrupt disabling of at least one of the antennas from the task of data reception may severely impact receiver performance, even using the technique above. Thus, a WTRU needs to perform further steps to make sure that reliable communication is maintained while the measurement is being made. There are two techniques that a WTRU may utilize to do so; first, the WTRU can instruct the network to transmit at a higher power 130. This is typically available for continual communication channels, such as those carrying dedicated voice traffic. Since such power control commands are usually slow, the WTRU starts commanding a power ramp-up some time T_{ifm} before the start of an inter-frequency measurement time interval. A power ramp down is commanded immediately following the end of the inter-frequency measurement so that the impact on the system capacity is minimized. Alternatively, the WTRU can instruct the network to reduce the transmission rate, thus permitting the WTRU to maintain reliable reception at a constant power level. Such data rate commands are typically fast and therefore the data rate only needs to be reduced for a period of time just slightly larger than the inter-frequency measurement interval.

Once the network has implemented the power level and/or data rate changes request by the WTRU, the WTRU can switch the at least one selected antenna and perform the inter-frequency measurements 140. When inter-frequency measurements are complete, the WTRU switches the at least one selected antenna back to the original frequency and to be utilized as receive diversity antennas 150. When this is complete, the WTRU should instruct the network to return the power level/data rate to the settings prior to the commencement of the inter-frequency handover process 160.

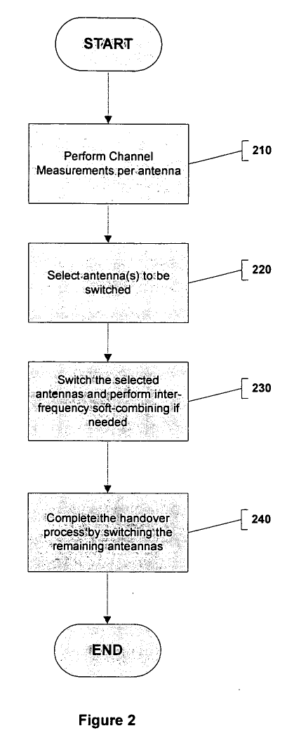

The method of the invention may further be utilized for performing inter-frequency handover as shown in FIG. 2.; First, based on the per-antenna channel measurements 210 performed in the receiver of the WTRU, at least one antenna is selected to be switched to be used for inter-frequency measurements is to be determined 220, this number should be at least 1 and no more than the total number of antennas present less 1, so that at least 1 antenna remains tuned to the original frequency. It should be noted that 210 is identical to 10 in FIG. 1 and 220 is identical to 20 in FIG. 1. It should be noted that selecting the antenna(s) for inter-frequency handover can be selected arbitrarily or based on other criteria, and not based on channel quality measurements.

Once the at least one antenna for inter-frequency handover has been selected, it may be switched to the new frequency 230. At this point the receiver may either begin demodulating data from the new frequency only, abandoning data demodulation from the previous frequency. This results in a hard handover, which is typical in most modern systems. Alternatively, the receiver may combine signals from the two frequencies, which results in a soft inter-frequency handover. The ability to support soft combining from different frequency is not supported in typical cellular system and is uniquely enabled by the present invention.

It should be noted that since the network is typically aware of the handover process, there is typically no need to command the network to adjust its rate/power in preparation to switching the at least one selected antennae. However, in another embodiment, the WTRU performs this additional step before step 230, the process being identical to step 30 in FIG. 1.

Finally, the inter-frequency handover process is completed when all the antennas are switched to the new frequency, 240.

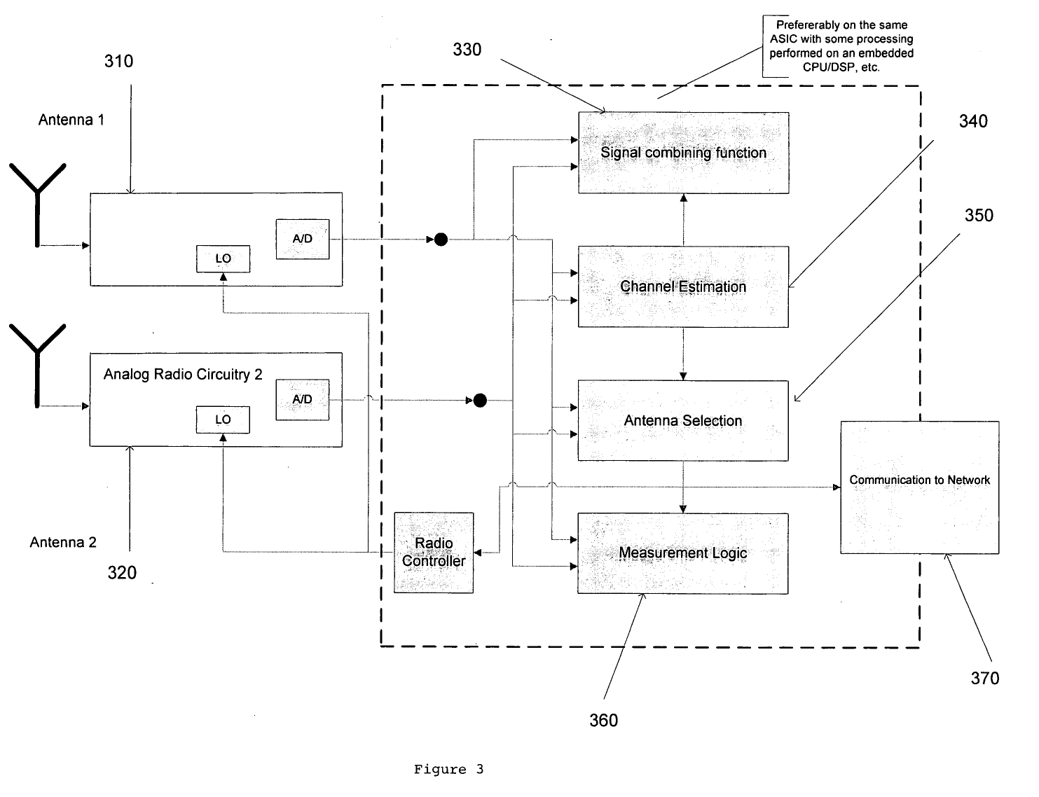

The invention includes a WTRU, as shown in FIG. 3, for performing inter-frequency measurements and inter-frequency handover described above in the description of the method of the invention. The WTRU includes at leas two antennas 310 320, each antenna is capable of being tuned at least a first and a second frequency. The WTRU also includes a channel estimation element 340. The implementation of the channel estimation is known to those skilled in the art and can be implemented in hardware, software, firmware, or any other part of the system that can execute the estimation algorithm. The channel estimation element will estimate the quality of the channel for each of each of the antennas in the WTRU.

The WTRU in the invention includes an antenna selection element 350. The antenna selection element will be used to select the antenna or antennas to be used for performing inter-frequency measurements and will also be used in performing inter-frequency handover. In a preferred embodiment, the antenna selection element will use the estimates from the channel estimation element to select the antenna with lowest channel quality to perform inter-frequency measurements. In another embodiment, the antenna selection element will arbitrarily or randomly select an antenna to perform inter-frequency measurements. The antenna selection element will select an antenna or antennas to perform inter-frequency handover.

The WTRU includes a communication element 370, for communication with the network to instruct the network to perform power control and rate control functions, when the WTRU initiates inter-frequency measurements and inter-frequency handover. As described in the method of the invention, when the WRTU starts performing inter-frequency measurements, at least one antenna will be used to perform the measurements. The loss of this antenna from receiving data The WTRU includes a signal combining function 330 for combining signals from at least two base stations operating at two different frequencies. The signal combining function can perform hard inter-frequency handover, or soft inter-frequency handover. In the case of hard inter-frequency handover, the WTRU switches all antennas from the first frequency base station to the second frequency base station without combining the signal at any point during the handover. In soft inter-frequency handover, the WTRU combines the signals from the different base stations. The combining of the signals in the soft handover can be based on various techniques that are known to people skilled in the art, with the objective of the combining is to maximize the received signal quality.

What is claimed is:

1. A method for performing inter-frequency measurements in a Wireless transmitter/receiver unit (WTRU), in a cellular network system, the system including a WTRU having two or more antennas or groups of antennas, each antenna or each group of antennas is capable of being tuned at least a first and a second frequency, the method comprising the steps of:
selecting at the WTRU at least one antenna to perform inter-frequency measurements;
instructing the network, at the WTRU, to transmit at a higher power or lower data rate;
switching at least one selected antenna, at the WTRU, to perform inter-frequency measurements;
switching, at a WTRU, the selected antenna back to the first frequency to be utilized as receive diversity antennas; and
instructing, at a WTRU, the network to return the power level and data rate settings prior to the commencement of the inter-frequency measurement process.

2. The method according to claim 1, wherein the cellular system is a CDMA system.

3. The method according to claim 1, further including the steps of:
selecting at the WTRU at least one antenna to perform inter-frequency measurements, wherein the antenna with the lowest channel quality is selected to perform inter-frequency measurements.

4. A method for performing handover of a Wireless transmitter/receiver unit (WTRU), in a cellular network system, from a first base station operating at a first frequency to a second BS operating at a second frequency, the system including a WTRU having two or more antennas or groups of antennas, each antenna or each group of antennas is capable of being tuned to a first and a second frequency, the method comprising the steps of:
selecting at the WTRU at least one antenna to perform inter-frequency handover; and
switching at least one selected antenna, at the WTRU, to perform inter-frequency handover.

5. The method according to claim 4, further including the steps of:
demodulating data from the second frequency only, abandoning data demodulation from the first frequency; and
switching all the antennas to the second frequency for receiving data to complete the handover.

6. The method according to claim 4, further including the step of:
performing soft inter-frequency handover by combining received signals from the first frequency and the second frequency; and
switching all the antennas to the second frequency for receiving data to complete the handover.

7. A Wireless transmitter/receiver unit (WTRU), in a cellular network system, for communicating with ate least a first base station operating at a first frequency and a second BS operating at a second frequency, the WTRU is capable of performing inter-frequency measurements and inter-frequency handover, the WTRU comprises:
at least a first antenna and a second antenna, said first antenna and said second antenna are capable of receiving at a first frequency and a second frequency;
means for performing channel estimation to evaluate a channel quality for each antenna; and
means for performing antenna selection, using an antenna selection element, for selecting an antenna, from at least said first antenna and said second antenna, to perform inter-frequency measurements and inter-frequency handover.

8. A wireless transmitter/receiver unit according to claim 7, further comprising:
a communication element for communicating with a network, to instruct the network to control power and data rates.

9. A wireless transmitter/receiver unit according to claim 7, further comprising:
a signal combining function for use in handover that is capable of performing hard inter-frequency combining as well as soft inter-frequency combining.
